(19) United States
(12) Patent Application Publication
(10) Pub. No.: US 2020/0129376 A1
(43) Pub. Date: Apr. 30, 2020

(54) PHARMACEUTICAL PACKAGING

(71) Applicant: Edelmann USA, Inc., South Pasadena, CA (US)

(72) Inventor: Antonio Diaz, South El Monte, CA (US)

(73) Assignee: Edelmann USA, Inc., South Pasadena, CA (US)

(21) Appl. No.: 16/669,106

(22) Filed: Oct. 30, 2019

Related U.S. Application Data
(60) Provisional application No. 62/752,955, filed on Oct. 30, 2018.

(51) Int. Cl. A61J 1/03; A61J 7/00

(52) U.S. Cl. CPC A61J 1/03; A61J 7/0084

(57) ABSTRACT

A pharmaceutical packaging which includes access resistant features includes an outer shell, an insert, and a compartment with a divider tray. When the compartment is placed in an interior of the outer shell, the compartment engages with the insert through a first detent element on the insert, and a second detent element on the compartment, the first detent element and second detent element forming a detent arrangement. To release the detent arrangement and gain access to the pharmaceutical packaging, a user must exert a force on release sections of the outer shell. The actuation of the release sections disengage the detent arrangement and allow the user to access the compartment.

### CROSS-REFERENCE TO RELATED APPLICATIONS

This application claims the benefit of U.S. Provisional Application No. 62/752,955 filed Oct. 30, 2018, the contents of which are expressly incorporated herein by reference.

### STATEMENT RE: FEDERALLY SPONSORED RESEARCH/DEVELOPMENT

Not Applicable

### BACKGROUND

### 1. Technical Field

The inventive subject matter pertains to access resistant packaging. More particularly, aspects of the inventive subject matter pertain to a package including a rectangular box with at least one sliding compartment inside. The rectangular box and the sliding compartment may be configured to restrict access to an interior of the sliding compartment by requiring prescribed manual manipulation (e.g., depression of release tabs) to access the interior of the sliding compartment

### 2. Description of the Related Art

Access resistant packages are known in general. Most commonly, such packages take the form of pill bottles with tamper resistant caps. The cap generally needs to be manipulated in some manner other than twisting in order to remove the cap from the bottle. For example, a user may have to press the cap toward a mouth of the bottle while twisting in order to remove the cap. Because such a movement may be difficult for certain categories of people, specifically children, the packaging may be access resistant.

Access resistant rectangular cardboard boxes with at least one blister pack inside the cardboard box are also known. The blister pack (referred to in the following as “the blister”) may include a strip of stiff plastic material, in which deep-drawn cups are formed. The deep-drawn cups may hold pills, tablets, capsules, suppositories, etc. After the cups have been filled, they may be sealed by a cover foil of limited tensile strength, which may be bonded to the plastic strip. This cover foil usually comprises metal, and typically aluminum. To remove the medication from the cup, the medication may be pushed from the rear of the strip against the cover foil, which is thus broken open. The stiffness of the plastic strip material in the area of the cup may be reduced to such an extent, usually by the deep-drawing process itself, that it is possible to deform the cup by manual pressure.

It is possible that during unsupervised play, small children could gain access to the medication present in some blister designs. Making a blister have more childproof qualities, however, may demand a relatively expensive design. Prior art involving childproof blisters can be found in, for example, U.S. Pat. No. 4,125,190 A, EP 1 057 744 A2, EP 1 002 744 A1, and U.S. Pat. No. 6,047,829 A. Most of these previously known blister packages, however, are childproof only up to the time they are first opened. In some blister designs, once the package has been broken open or unsealed the same may represent a danger to small children as it may be incapable of being re-closed in the same child resistant configuration.

Further blister packaging with additional access resistance features are known. Such designs may include combinations of blister packages with box enclosures, and after the box has been opened the first time, the box can be reclosed in such a way as to be access resistant again. The blister package and the cardboard box in such designs may include retention members which may be selectively released before the blister package may be pulled from the cardboard box. When the blister package is re-inserted in the cardboard box, the retention members may re-engage. For example, a box and blister pack design is shown and described in U.S. Pat. No. 7,690,510 issued Apr. 6, 2010 to Sattel, et al, the content and substance of which is incorporated herein by reference.

However, while blister packs, and combination blister packs and cartons may be useful for items that are compatible for enclosures within blister pack cups, such as pills, which may be discretely packaged, they may be less suitable for other less traditional pharmaceutical forms or other controlled items for which regulation or industry requirements mandate access resistant packaging or child-proof packaging. As such there is a need in the art for child-proof carton enclosures or access resistant enclosures that may contain items other than pills or capsules that are not presented in blister pack form, that are tamper evident and also provide re-closure to the access resistant state after opening.

### BRIEF SUMMARY

Disclosed herein are various aspects of pharmaceutical packaging for preventing access to content stored in the pharmaceutical packaging. According to one embodiment, there is provided an access resistant package comprising a housing having a first end, and a second end opposite the first end, with the second end including an opening. An internal recess extending from the first end to the second end. The housing further includes a first housing abutment extending within the internal recess. The access resistant package additionally comprises a tray having an open faced storage compartment and a first tray abutment, with the tray being insertable within the internal recess and selectively positionable relative to the housing in a first position and a second position. In the first position, the tray is positioned within the internal recess such that the housing covers the open faced storage compartment and the first housing abutment engages the first tray abutment to restrict inadvertent removal of the tray from the internal recess. In the second position, a portion of the tray extends through the opening and out of the internal recess to facilitate access to the open faced storage compartment, with the first housing abutment being moved out of engagement with the first tray abutment to facilitate movement of the tray from the first position toward the second position.

The first tray abutment may be moveable and disengageable from the first housing abutment in response to application of a force which urges the first tray abutment toward the storage compartment.

The tray may include a first portion including the first tray abutment, and a second portion, the first tray abutment being moveable relative to the second portion to facilitate disengagement of the first tray abutment from the first housing abutment. The tray may include a slit extending between the first portion and the second portion.

The housing may include a second housing abutment extending within the internal recess and the tray includes a second tray abutment engageable with the second housing abutment when the tray is in the first position, the second housing abutment being moved out of engagement with the second tray abutment to facilitate movement of the tray from the first position toward the second position. The package may define a longitudinal axis along which the tray is moveable relative to the housing, and the first and second tray abutments may be spaced from each other along the longitudinal axis to define an offset configuration.

The housing may include a body and an insert positioned within the body, with the insert including a distal edge defining the first abutment. The tray may be slidable relative to the insert as the tray transitions from the first position to the second position.

The tray may include a bottom surface having a slit formed therein and the housing may include a stop extending into the internal recess, with the stop being received in the slit when the tray is in the second position to restrict further removal of the tray from the housing.

The tray may include a divider wall separating the storage compartment into two zones.

The pharmaceutical packaging may have a proximal end and a distal end. The pharmaceutical packaging may include an outer shell including a closed end, at least three sides, and at least one release section on one of the at least three sides. Further, each of three sides may include an interior surface, and the at least three sides may define an end opening and an interior. The pharmaceutical packaging may further include an insert in the interior. The insert may include at least one panel, a first end portion of the at least one panel adjacent the end opening, a middle section of the panel extending along the interior surface of one of the at least three sides, and a second end portion opposite the first end portion and located spaced apart from the closed end, the insert including an interior surface and a first detent element on the second end portion. The pharmaceutical packing may further include a compartment in the interior, at least a portion of the compartment abutting the interior surface of the insert. Another portion of the comportment may abut the interior surface of one of the at least three sides. The compartment may include a pull tab, a first side wall, a second side wall, and a bottom connecting the first and second side walls. At least one of the first side wall and second side wall may include a second detent element. The first detent element and the second detent element may form a detent arrangement, and the compartment may have a first position and a second position. In the first position the detent arrangement may prevent movement of the compartment toward a proximal end opening of the outer shell, and in the second position the second detent element may be proximal of the first detent element. In order to move the compartment from the first position to the second position, a user may exert a force on the at least one release section. The force may disengage the first detent element and the second detent element, and, while the user may still be exerting a force on the at least one release section, the user may exert a force on the pull tab, moving the compartment relative to the end opening and translating the compartment until the second detent element is proximal of the first detent element.

Further disclosed is the pharmaceutical packaging wherein the second detent element may be biased in to engagement with the first detent element by a fold line of one of the first side wall and second side wall.

Further disclosed is the pharmaceutical packaging which may further comprise a blocking flap on the outer shell which folds about a fold line defined by the connection between the blocking flap and one of the at least three sides. The blocking flap may be located in the interior. The blocking flap may further include chamfered shoulders near the fold line.

Further, the pharmaceutical packaging may include where the flap further comprises a catch tab which is located between the flap and one of the at least three sides. The catch tab may capture a hooking tab extending from an exterior surface of the bottom of the compartment as the compartment is moved toward a proximal end portion opening.

Further disclosed is where the outer shell may further comprise an opening tab folded back upon the outer shell, and attached to the outer shell. The opening tab may include at least one frangible line of weakness.

Further disclosed is where the outer shell of the pharmaceutical packaging may further include a second release section.

Further disclosed is where the at least one release section and second release section of the pharmaceutical packaging may be offset.

Further disclosed is where the at least one release section of the pharmaceutical packaging may include at least one slit.

Further disclosed is where the at least one release section of the pharmaceutical packaging may include two slits.

Further disclosed is where the outer shell of the pharmaceutical packaging may further comprise a blocking tab folded in to the interior. The blocking tab may include at least one shoulder which holds the insert in place.

Further disclosed is that the blocking tab may further include a catch tab. The catch tab may interact with a hooking tab on the compartment to prevent removal of the compartment from the outer shell.

Also disclosed is a method of assembling pharmaceutical packaging. The method may include folding an outer shell along fold lines. The fold lines may define a plurality of panels, each of the plurality of panels having an interior surface, and at least one of the plurality of panels including a release section. The plurality of panels may be folded such that at least one of the plurality of panels overlaps a second one of the plurality of panels, and the folded outer shell may define an interior. The method may further include placing an insert including at least one panel in the interior so that an exterior surface of the at least one panel abuts the interior surface of at least one of the plurality of panels of the outer shell. The at least one panel may include a first detent element on a first end. The method may further include placing a compartment in the interior. The compartment may include at least one side wall, the side wall including a second detent element. The compartment may be placed in the interior such that the first detent element and second detent element form a detent arrangement, the detent arrangement may be disengaged by a user providing a force on the release section.

Further disclosed is where the method may further comprise providing a second release section on a second of the plurality of panels.

Further disclosed is where the at least one of the plurality of panels may include a release section and the second of the plurality of panels may include the second release section. The at least one of the plurality of panels and the second of the plurality of panels may oppose one another.

Further disclosed is wherein the second release section and the release section may be longitudinally offset.

The method may further comprise proving a blocking flap on the outer shell, the blocking flap may be located in the interior.

Further disclosed is where the blocking flap may include shoulders which prevent movement of the insert.

The method may further comprise providing a second panel on the insert, the second panel may include another first detent element.

The method may further comprise providing a second side wall of the compartment, and the second side wall may include another second detent element.

Further disclosed is where the another first detent element and another second detent element may form a second detent arrangement, the second detent arrangement longitudinally offset from the detent arrangement.

The access resistant packaging disclosed herein may include an elongate package housing having four elongate housing walls, a closed second end and a first end. The first end may have an opening, and said elongate housing walls may form an interior surface. At least one of said elongate housing walls may have a pliable region and may have at least one raised surface formed on an interior of said housing wall. The elongate package housing may have a package tray. The package tray may have a bottom, elongate tray sides walls and front and rear walls. The package tray may be sized to be received within the package housing through the opening of the first end, said package tray having at least one elongate tray side wall having a deformable catch. Said package tray may be insertable into the package housing in at least a first position and a second fully inserted position. In the first position, the deformable catch may not be engaged with the raised surface of the elongate side wall, and in the second position the deformable catch may expand outwardly to catch the raised surface keeping the tray from being removed from the package housing. Applying force to the pliable region of said housing wall may cause said deformable catch to move inwardly to release the catch and may allow removal of the tray from said housing.

The pliable region comprises two cuts formed into the elongate housing wall, the area between the cuts defining a deformable area on the elongate housing wall. The pliable regions are formed on opposed elongate housing walls. The pliable regions are not directly opposed, but rather are staggered or off-set to make the access resistance features more challenging to the user. The deformable catch in the tray member is formed by a vertical cut in the at least one of the elongate tray side walls. The housing and tray insert may be formed of cardboard or plastic or other such material as is suitable packaging.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an exploded perspective view of an embodiment of pharmaceutical packaging;

FIG. 2 shows a plan view of an outer shell master panel in an unfolded configuration;

FIG. 3 shows a perspective view of the outer shell in a folded configuration;

FIG. 4 shows a staggered transverse cross section view of the outer shell;

FIG. 5 shows the staggered transverse cross section view of FIG. 4 with an inward force being applied to the release sections;

FIG. 6 shows a plan view of an insert panel in an unfolded configuration;

FIG. 7 shows a perspective view of the insert formed from folding the insert panel of FIG. 6;

FIG. 8 shows a plan view of a compartment panel in an unfolded configuration;

FIG. 9 shows a perspective view of a partially assembled (e.g., folded) compartment;

FIG. 10 shows a plan view of a divider tray panel in an unfolded configuration;

FIG. 11 shows a perspective view of a partially assembled (e.g., folded) divider tray;

FIG. 12a shows a plan view of another embodiment of a divider tray platform panel in an unfolded configuration;

FIG. 12b shows a perspective view of an assembled (e.g., folded) divider tray platform;

FIG. 12c shows a plan view of a cartridge holder panel in an unfolded configuration;

FIG. 12d shows a perspective view of an assembled (e.g., folded) cartridge holder;

FIG. 13 shows a perspective view of an assembly including the outer shell and insert;

FIG. 14 shows a perspective view of the assembly of the outer shell and insert aligned with a compartment and divider tray;

FIG. 15 shows a perspective view of an assembled pharmaceutical packaging having an end portion thereof transitioned to an open configuration;

FIG. 16 shows a perspective view of the pharmaceutical packaging with release sections actuated by a user and the compartment being removed;

FIG. 17 shows a staggered transverse cross section view of the assembled pharmaceutical packaging of FIG. 15;

FIG. 18 shows a staggered transverse cross section view of the assembled pharmaceutical packaging of FIG. 16 with the release sections actuated;

FIG. 19 shows a longitudinal cross section view of the pharmaceutical packaging having an end portion in an open configuration and the tray in a stored configuration;

FIG. 20 shows a longitudinal cross section view of the opened pharmaceutical packaging with the tray extended such that a catch tab and a hook tab are engaged;

FIG. 21 shows a perspective view of another embodiment of the outer shell;

FIG. 22 shows a plan view of the outer shell master panel of the outer shell of FIG. 21 in an unfolded configuration;

FIG. 23 shows a perspective view of another embodiment of an insert;

FIG. 24 shows a plan view of an insert panel in an unfolded configuration and used to form the insert of FIG. 23;

FIG. 25 shows a perspective view of a second embodiment of a compartment;

FIG. 26 shows a plan view of a compartment panel in an unfolded configuration and used to form the compartment of FIG. 25;

FIG. 27 shows a second embodiment of a divider tray;

FIG. 28 shows a plan view of a divider tray panel in an unfolded configuration and sued to form the divider tray of FIG. 27;

FIG. 29 shows a perspective view of the pharmaceutical packaging with graphics marking the release section; and

FIG. 30 shows a side plan view of the pharmaceutical packaging of FIG. 29.

### DETAILED DESCRIPTION

The detailed description set forth below in connection with the appended drawings is intended as a description of the presently contemplated embodiments of access resistant and pharmaceutical packaging, and is not intended to represent the only form in which the disclosed subject matter may be developed or utilized. The description sets forth the various functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

Pharmaceutical packaging which is access resistant and methods of assembly therefore are contemplated by the present disclosure. The pharmaceutical packaging includes several components which interact to provide the access resistance. An outer shell may house an insert and a compartment. The insert may include a first detent element and the compartment may include a second detent element. The first and second detent elements may engage one another to form a detent arrangement. The detent arrangement prevents a user from accessing the compartment. In order to access the compartment, a user must apply an inward force to at least one release section on the outer shell. The outer shell may include more than one release section, for example, there may be two release sections, on each on opposing sides of the outer shell. The application of the inward force to the release section disengages the detent arrangement. While applying the inward force to the release section, if a user pulls a pull tab on the compartment, the compartment may slide, allowing access to the compartment.

It is contemplated that the packaging of the disclosed inventive subject matter may be shipped as a system of flat or substantially flat panels for final assembly by an entity other than the manufacturer of the panels. In this way, the packing uses less storage space until assembly, which may take place at any time up to immediately before use.

As used herein, proximal refers to the end of the pharmaceutical packaging which a user may open to access the product stored in the pharmaceutical packaging. Distal refers to the end of the pharmaceutical packaging longitudinally opposite the proximal end.

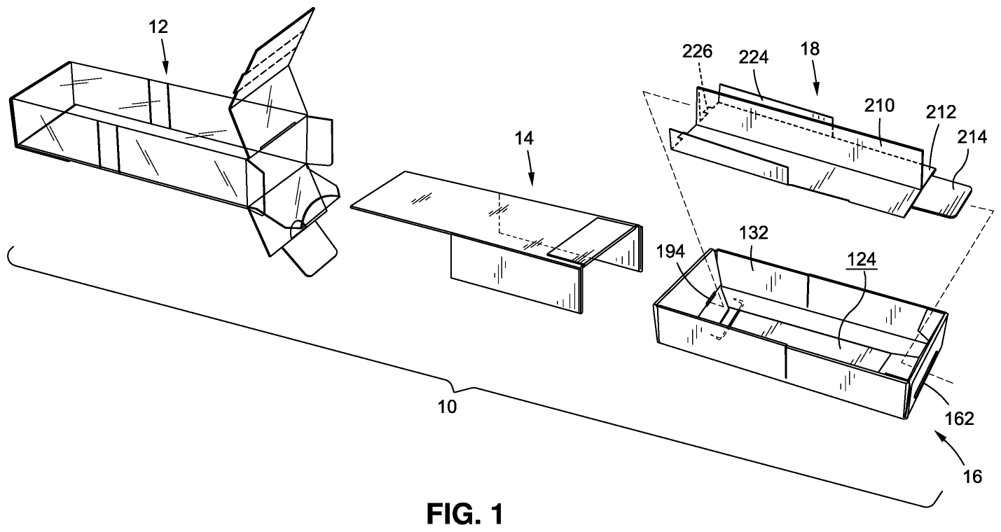

FIG. 1 shows an exploded view of the components of a first embodiment of the pharmaceutical packaging 10. The pharmaceutical packaging 10 may include an outer shell 12, an insert 14, and a compartment 16, which may further include a divider tray 18. As described in further detail below, each of the outer shell 12, insert 14, compartment 16, and divider tray 18 may be formed by folding a panel along predetermined lines.

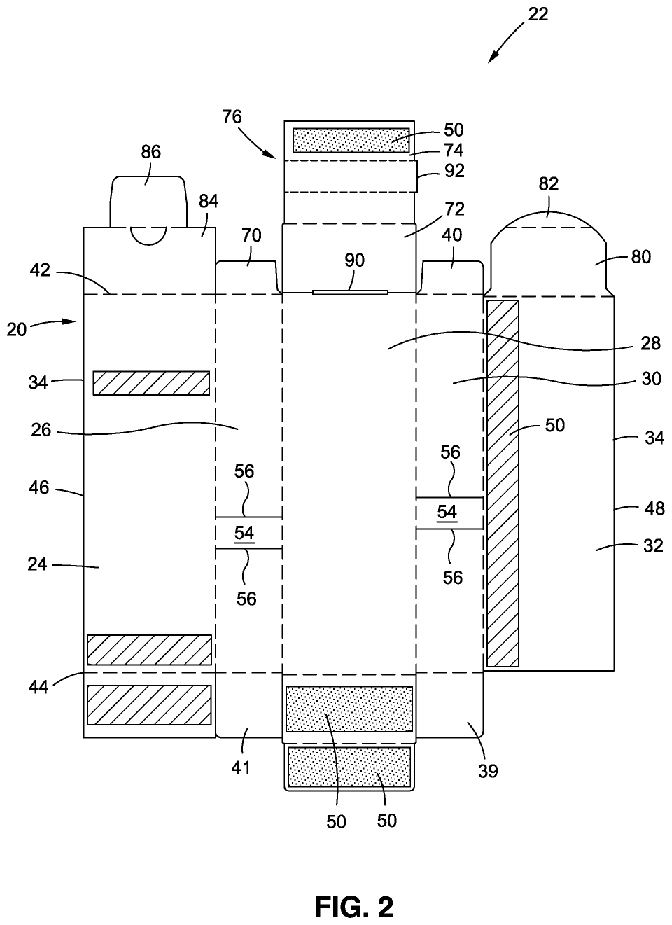

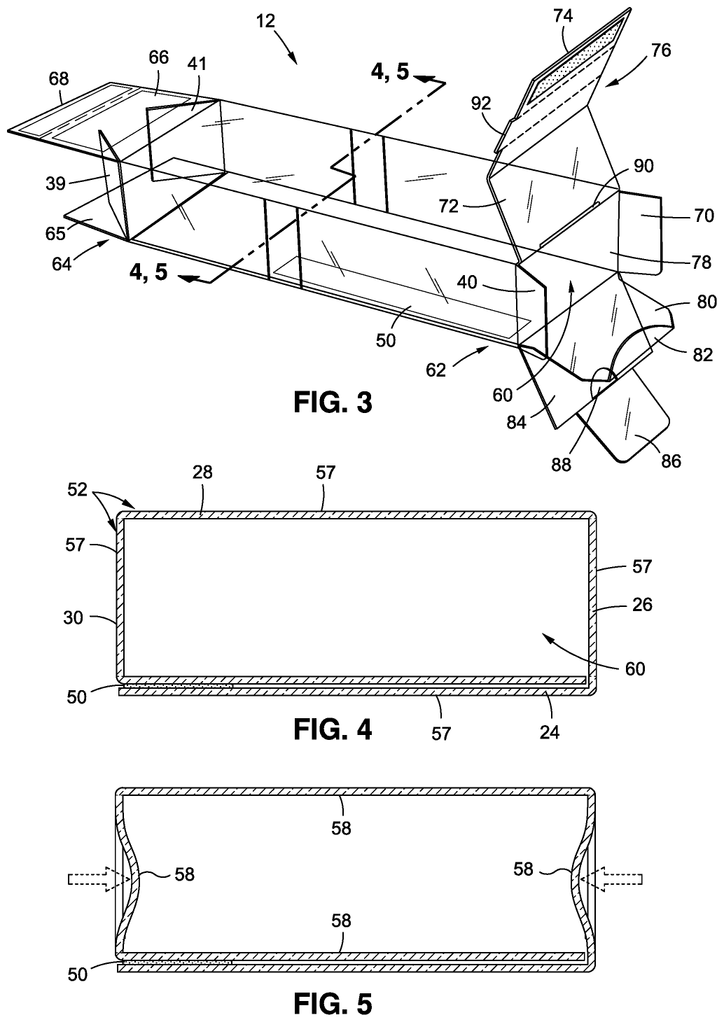

As shown in FIGS. 2-3, the outer shell 12 may be assembled from a single outer shell master panel 22 defining collective panel sections 20. In the example of FIG. 2, the outer shell master panel 22 that defines collective panel sections 20 may include a first panel section 24, a second panel section 26, a third panel section 28, a fourth panel section 30, and a fifth panel section 32. Each of the panel section's 24, 26, 28, 30, 32 shape may be defined by fold lines. The shape of some of the panel sections 24, 26, 28, 30, 32 may be further defined by exterior edges 34 of the outer shell master panel 22. When the collective panel sections 20 are folded along fold lines, the same may form an elongate rectangular box as shown in FIG. 3. Alternatively, the outer shell master panel 22 may include as few as three panel sections 20 to possibly form a triangular structure having three elongate sides. The panel sections 20 may be of the same shape, that is, each of the first through fifth panel sections may have the same width and length. Alternatively, the panel sections 20 may have different length or width, or both a different length and width.

The first panel section 24, third panel section 28, and fifth panel section 32 may be of substantially the same size (e.g., length and width). The third panel section 28 may be disposed between the first panel section 24 and fifth panel section 32. The first panel section 24 and the third panel section 28 may be connected by a second panel section 26. The second panel section 26 may have the same length as the first panel section 24 and the third panel section 28, but a different width. Similarly, the fourth panel section 30 may connect the third panel section 28 to the fifth panel section 32. The fourth panel section 30 may have a width substantially similar to that of the second panel section 26. Each of the panel sections 24, 26, 28, 30, 32 may connect to the adjacent panel sections 24, 26, 28, 30, 32 along a longitudinal edge defined by the fold lines.

One or more flaps or tabs may extend from a proximal shared transverse edge (or end) 42 of the panel sections 24, 26, 28, 30, 32 or a distal shared transverse edge (or end) 44, opposite the first shared transverse edge 42 of the panel sections 24, 26, 28, 30, 32. The shared transverse edges 42, 44 may extend across the outer shell master panel 22 from a first edge 46 to an opposite second edge 48 of the outer shell master panel 22. Flaps may be referred to herein as having at least two free edges that extend from one or more panels. Tabs may be referred to herein as portions which extend from flaps and have more than two free edges. Free edges are defined as edges which are not connected to other panel sections or flaps of the outer shell master panel 22. Alternatively, tabs may have a single or multiple curved edges which extend from flaps and the free edges are also not connected to any other structure of the outer shell 12.

At least one of the panel sections 24, 26, 28, 30, 32 may include a release section 54. The release section 54 may be formed by cutting a slit 56 across the width of one of the panel sections 24, 26, 28, 30, 32 between adjacent fold lines defining the width of the respective panel section. Alternatively, the release section 54 may be formed by cutting two slits 56 across the width of one of the panel sections 24, 26, 28, 30, 32. The slits 56 may be cut substantially parallel, or the slits 56 may be cut at an angle to one another. The slit(s) 56 may allow the release section 54 to bend or flex relative to the remainder of the respective panel section. As will be described in greater detail below, one of the slits 56 may be cut to align with an end edge of a side panel section of the insert 14.

As shown in FIGS. 2-5, the outer shell master panel 22 may be folded along fold lines to form the outer shell 12. Specifically, each of the first panel section 24, second panel section 26, third panel section 28, fourth panel section 30, and fifth panel section 32 may be folded along the fold lines formed along the longitudinal edges of the panel sections 24, 26, 28, 30, 32. The folds are made along the fold lines all in the same direction. That is, when viewed along a longitudinal axis of the fold lines, the folds are all formed either by rotating an adjacent panel section 26, 28, 30, 32 clockwise or counterclockwise about the longitudinal axis of the respective fold line. As shown in cross sectional view of FIGS. 4 and 5, the first panel section 24 and the fifth panel section 32 may be made to overlap when folded. The fifth panel section 32 may include an adhesive strip 50 which may be used to secure the first panel section 24 to the fifth panel section 32. Alternatively, rather than overlapping panel sections, panel sections on opposite sides may be joined along a free edge. When the first panel section 24 is secured to the fifth panel section 32, the first panel section 24 and fifth panel section 32 form one side section 52 of the outer shell 12. The second panel section 26, third panel section 28, and fourth panel section 30 form additional sides 52 of the outer shell 12. Alternatively, the outer shell 12 may have a few as three sides 52. Each of the sides 52 may have an exterior surface 57 and on opposite interior surface 58. In FIG. 2, adhesive strips are shown attached plan view of master panel 22 diagonal lines, or dotted areas as adhesive strips 50. The adhesive strips may come pre-affixed to the panels for ease of construction. As adhesive strips or adhesive regions are referred to throughout this disclosure, it is understood that any referenced adhesive strips may come pre-applied to the panels with non-stick paper to keep the adhesive intact until the user is ready to assemble, and they can remove the non-stick paper to expose the adhesive for use. Alternatively, the adhesive regions simply may demonstrate the correct location to apply adhesive for assembly.

When two of the folded panel sections 24, 26, 28, 30, 32 are connected either at free edges or two of the folded panel sections are connected by overlapping the two panel sections, and then joining the overlapping panel sections, for example, by the adhesive strip 52, the sides 52 of the outer shell 12 may define an interior 60.

The interior 60 may further be defined by a proximal end portion 62, and a distal end portion 64 of the outer shell 12. The proximal end portion 62 and the distal end portion 64 may be formed by the sides 52, flaps, and tabs of the outer shell master panel 22. In the example of FIG. 3, the distal end portion 64 may be formed by folding two opposing tabs 39, 41 in toward one another. Then, a single wider tab 65 is folded around an axis orthogonal to the folding axis of the first two tabs 38, 40. Finally, a distal closure flap 66, with a tab 68 extending therefrom, may be folded in an opposite direction around an axis parallel to the folding axis of the single wider tab 65. Both the distal closure flap 66 and the tab 68 may have an adhesive strip attached thereto. When folded flush to an exterior surface of the single wider tab 65, the adhesive holds the distal closure flap 66 to the single wider tab 65. The tab 68 may be folded about a fold line and then flush to the side 52 which shares a fold line with the single wider tab 65. Once the adhesive on the distal closure flap 66 and the tab 68 is adhered to the single wider tab 65 and the side 52, the distal end portion 64 of the outer shell 12 is closed. Because of the use of the adhesive strips, the distal end portion 64 may be closed by the attachment of the adhesive strips unless a user chooses to destructively open it.

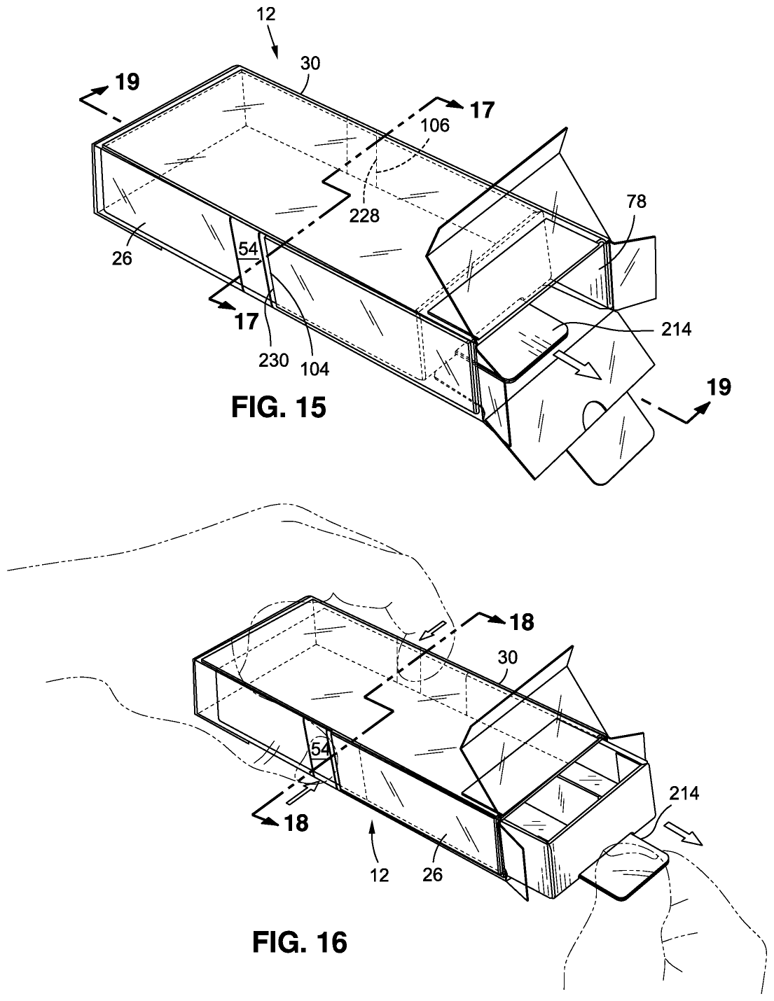

The proximal end portion 62 may include a plurality of tabs and flaps. Specifically, the proximal end portion 62 may include two opposing lateral tabs 40, 70. The proximal end portion 62 may further include an opening flap 72 and opening tab 74. The opening tab 74 may further include both an adhesive strip and at least one frangible line of weakness 76, shown as parallel frangible lines of weakness 76 in FIG. 3. As can be seen in FIGS. 2, and 3, the at least one frangible line of weakness 76 may be located between the fold line which connects the opening flap 72 and the opening tab 74 and the adhesive strip on the opening tab 74. Thus, as shown in FIGS. 15 and 16, if a user completely separates the at least one frangible line of weakness 76 on the opening tab 74, the opening flap 72 and the portion of the opening tab 74 between the opening flap 72 and the frangible line of weakness 76 is free to be folded out of the way of a user accessing the interior 60 of the outer shell 12.

When the outer shell 12 is created by overlapping the first panel section 24 and fifth panel section 32, one side of a perimeter defining a proximal end portion opening 78 may have a plurality of flaps or tabs, or both. FIG. 4 shows a transverse cross section of the outer shell 12 with the overlapping first panel section 24 and fifth panel section 32. The fifth panel section 32 may be the more inner panel section of the side 52 including the first panel section 24 and the fifth panel section 32. The fifth panel section 32 may include a blocking flap 80 and catch tab 82. The blocking flap 80 may include two chamfered shoulders 112 near the fold line between the blocking flap 80 and the fifth panel section 32. The blocking flap 80 may also include angled edges to either side of the catch tab 82. Both the blocking flap 80 and catch tab 82 may be folded into the interior 60 of the outer shell 12.

The first panel section 24 may include a covering flap 84, a resealing tab 86, and a push tab 88. When the proximal end portion 62 is initially sealed as described above, the resealing tab 86 and push tab 88 may be tucked into the interior 60. When tucked into the interior 60, the resealing tab 86 rests against an interior surface of the side 52 of the outer shell 12 formed by the third panel section 28. Further, the fold line between the side 52 and the opening flap 72 may include a slot 90. The slot 90 is sized to accept the resealing tab 86 as further described below. The push tab 88 may be connected to the resealing tab 86 across the fold line separating the resealing tab 86 and the push tab 88. The push tab 88 formed by cutting out a semi-circular portion of the covering flap 84. Because the resealing tab 86 is connected to the push tab 88 across the fold line, pushing on the resealing tab 86 may act as a lever for the push tab 88 and vice versa. Alternatively, the resealing tab 86 may be placed through the slot 90 when the outer shell 12 is initially sealed. When the resealing tab 86 is placed through the slot 90 when the outer shell 12 is initially sealed, the resealing tab 86 may protrude. As such the resealing tab 86 may be used to hang the pharmaceutical packaging 10 from a fixture (not shown). Alternatively, the resealing tab 86 may be used to handle individual instances of pharmaceutical packaging 10 when a plurality of instances of pharmaceutical packaging 10 are stacked or placed in some larger form of packaging.

As shown in FIGS. 2 and 3, one configuration for the at least one frangible line of weakness 76 may be an in-line perforated seam. Further, when there are two frangible lines of weakness 76, the portion of the opening tab 74 defined by the frangible lines of weakness 76 may include a grip tab 92 which extends from an edge of the opening tab 74. The grip tab 92 may make it easier for a user to secure the portion of the opening tab 74 defined by the frangible lines of weakness 76 in order to open the pharmaceutical packaging 10. The grip tab 92 may be sacrificial (e.g., designed for a one-time use), such that once the grip tab 92 is torn along the parallel frangible lines of weakness, the package is open and will be evident that the package has been tampered with. As such, in a product display setting, it would be evident which packages have already been opened, even though the access resistance may have been reengaged by the closure of the package. The tamper evident features may be used as a warning to the user that the package has been tampered with or has been opened.

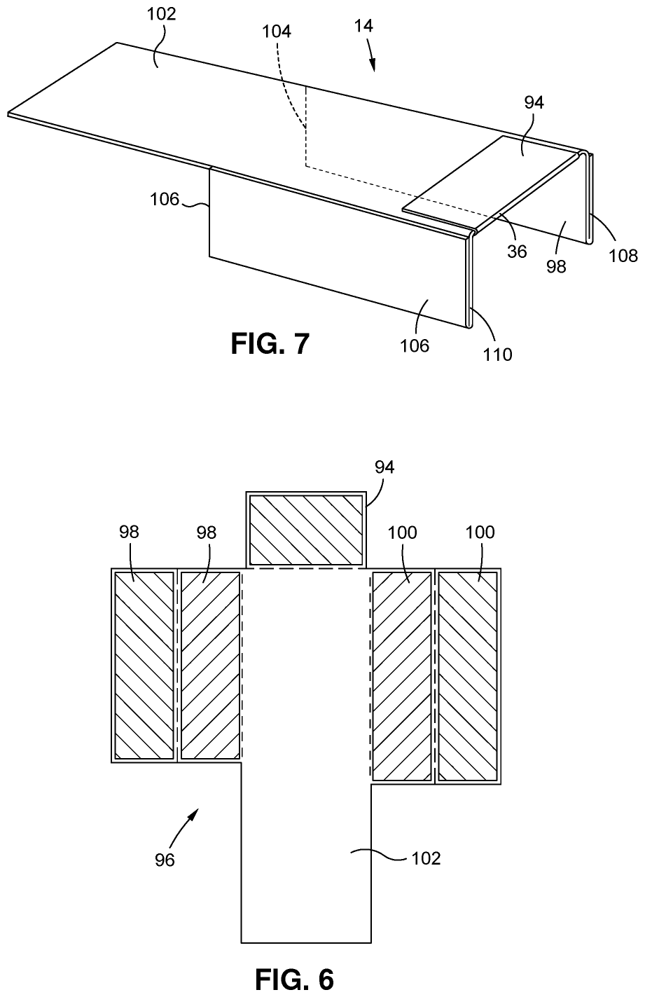

As best seen in FIGS. 6 and 7, the pharmaceutical packaging 10 may further include an insert 14. The insert 14 may include a central panel section 102, a stiffening tab 94 and at least one side panel 96. Where the insert 14 includes more than one side panel 96, the insert 14 may include one short side panel 98 and a second, opposite side may have at least one long side panel 100. Alternately or in addition, there may be two short side panels or two long side panels. That is, the side panels may be of equal length. The short side panels 98 may be a flap and a tab of equal dimension. The long side panels 100 may also be a flap and a tab of equal dimension. Each of the stiffening tab 94 and the at least one side panel 96 and 100 may include adhesive or all or part of an interior surface. In FIG. 6, the adhesive is shown by diagonal lining in the drawing on tab 94 and tabs 98 and 100.

As shown in FIG. 7, the stiffening tab 94 may be folded back onto the central panel section 102 along a fold line, which creates a leading edge 36. The short side panels 98 may be folded back onto one another along a shared fold line. The long side panels 100 may also be folded back onto one another along a shared fold line. The short side panels 98 and long side panels 100 may be folded along fold lines shared with the central panel section 102. The short side panels 98 and long side panels 100 may fold so that the folded edge of each of the pairs of short side panels 98 and long side panels 100 point in the same direction.

Turning now to the compartment 16, as noted above, the compartment 16 may have a divider tray 18 placed within. Similar to both the outer shell 12 and the insert 14, the compartment 16 and the divider tray 18 may be formed by folding flat cut out panels.

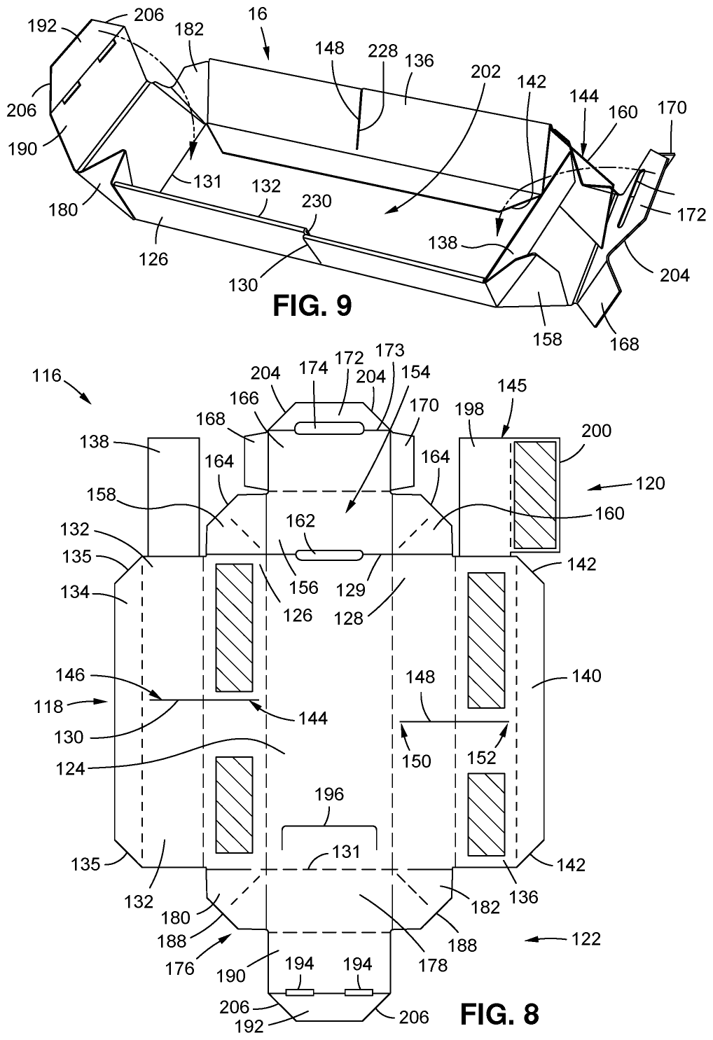

More specifically, as shown in FIGS. 8-12b the compartment 16 and divider tray 18 may be formed by folding separate pre-cut flat panels. A compartment panel 116 may be generally divided into center panel sections 118, proximal end flaps and tabs 120, and distal end flaps and tabs 122. The center panel sections 118 may include a base panel section 124. The base panel section 124 may include a hooking tab 196. The hooking tab 196 may be a three sided tab cut into an interior of the base panel section 124. An inner short side panel section 126 may be connected along a first longitudinal edge of the base panel section 124. The first longitudinal edge may be defined by a fold line. An outer short side panel section 132 may be connected along an outside edge of the inner short side panel section 126. A short side longitudinal support tab 134 may be connected along an outside edge of the outer short side panel section 132. The short side longitudinal support tab 134 may include two mitered ends 135. A single transverse tab 138 may extend from the proximal end of the outer short side panel section 132. A short side slit 130 may extend transversely across the inner short side panel section 126 and the outer short side panel section 132. The short side slit 130 may start at a first end region 144 spaced apart from the fold line defining the first longitudinal edge of the base panel section 124, and extend to a second end region 146 spaced equally apart from the fold line defining an edge between the outer short side panel section 132 and the short side longitudinal support tab 134. The outer short side panel section 132 and/or the inner short side panel section 126 may include adhesive strips on either side of the short side slit 130.

An inner long side panel section 128 may be connected along a second longitudinal edge of the base panel section 124. The second longitudinal edge may be defined by a fold line. An outer long side panel section 136 may be connected along an outside edge of the inner long side panel section 128. A long side longitudinal support tab 140 may be connected along an outside edge of the outer long side panel section 136. The long side longitudinal support tab 140 may also include two mitered ends 142. A double transverse tab 145 may extend from the proximal end of the outer long side panel section 136. The double transverse tab 145 may have an inner portion 198 connected to an outer portion 200. The outer portion 200 may include an adhesive strip. Adhesive strips are shown in FIG. 8 by diagonal lines representing adhesive areas on the panel 116. A long side slit 148 may extend transversely across the inner long side panel section 128 and the outer long side panel section 136. The long side slit 148 may start at a first end region 150 spaced apart from the fold line defining the second longitudinal edge of the base panel section 124, and extend to a second end region 152 spaced equally apart from the fold line defining an edge between the outer long side panel section 136 and the long side longitudinal support tab 140. The outer long side panel section 128 and/or the outer long side panel section 136 may include adhesive strips on either side of the long side slit 148.

A proximal end inner wall flap 154 may be connected to the proximal edge of the inner short side panel section 126, the base panel section 124, and the inner long side panel section 128 along a shared proximal edge 129. The proximal end inner wall flap 154 may be defined by fold lines which continue from the fold lines on the first longitudinal edge and second longitudinal edge of the base panel section 124. Those fold lines may divide the proximal end inner wall flap 154 into a proximal end central section 156, a proximal end short side fold section 158, and a proximal end long side fold section 160. A fold line which separates the base panel section 124 from the proximal end central section 156 may include a first cut out 162 which extends partly into the proximal end central section 156 and partly in to the base panel section 124. Each of the proximal end short side fold section 158 and the proximal end long side fold section 160 may include mitered corners 164. Each of the proximal end short side fold section 158 and the proximal end long side fold section 160 may include fold lines which extend at a 45 degree angle from the center of the mitered corners 164 to the intersection of the proximal end central section 156, the base panel section 124, inner short side panel section 126, and the proximal end short side fold section 158 or to the intersection of the proximal end central section 156, the base panel section 124, inner long side panel section 128, and the proximal end long side fold section 160, respectively. The fold lines on the proximal end side fold sections 158, 160 may mirror one another.

A proximal end outer end wall flap 166 may be connected to a proximal edge of the proximal end inner wall flap 154. The outer wall end flap 166 may include a first wing tab 168 and an opposing second wing tab 170. A proximal end transverse support tab 172 may extend from a proximal end edge 173 defined by a fold line of the proximal end outer wall end flap 166. The fold line between the proximal end transverse support tab 172 and the proximal end outer wall flap 166 may also include a second cut out 174. The second cut out 174 may extend partly into the proximal end transverse support tab 172 and partly in to the proximal end outer wall flap 166. The proximal end transverse support tab 172 may include mitered ends 204.

A distal end inner wall flap 176 may be connected to the distal edge of the inner short side panel section 126, the base panel section 124, and the inner long side panel section 128 along a shared distal edge 131. The distal end inner wall flap 176 may be defined by fold lines which continue from the fold lines on the first longitudinal edge and second longitudinal edge of the base panel section 124. Those fold lines may divide the distal end inner wall flap 176 in to a distal end central section 178, a distal end short side fold section 180, and a distal end long side fold section 182. Each of the distal end short side fold section 180 and the distal end long side fold section 182 may include mitered corners 188. Each of the distal end short side fold section 180 and the distal end long side fold section 182 may include fold lines which extend at a 45 degree angle from the center of the mitered corners 188 to the intersection of the central section 178, the base panel section 124, inner short side panel section 126, and the short side fold section 180 or to the intersection of the distal end central section 178, the base panel section 124, inner long side panel section 128, and the long side fold section 182, respectively. The fold lines on the distal end side fold sections 180, 182 may mirror one another.

Connected to a distal edge of the distal end inner wall flap 176 may be a distal edge outer end wall flap 190. A distal end transverse support tab 192 may extend from a distal end edge defined by a fold line of the distal end outer wall flap 190. The fold line between the distal end transverse support tab 192 and the distal end outer wall flap 190 may also include a pair of mating cut outs 194. The pair of mating cut outs 194 may extend partly in to the distal end transverse support tab 192 and partly in to the distal end outer wall flap 190. The distal end transverse support tab 172 may include mitered ends 206.

As shown in FIG. 9, which depicts the compartment in a partially folded or assembled configuration, the outer short side panel section 132 may be folded over the inner short side panel section 126 so that the two adhere to one another. The adhered outer short side panel section 132 and inner short side panel section 126 may be referred to as a side wall. The outer long side panel section 136 may be folded over the inner long side panel section 128 so that the two adhere to one another. The adhered outer long side panel section 136 and inner long side panel section 128 may also be referred to as a side wall. Then, the proximal end short side fold section 158, the proximal end long side fold section 160, the distal end short side fold section 180, and the distal end long side fold section 182 may be folded along the angled fold lines. The folding of the four fold sections 158, 160, 180, 182 causes the short side panel sections 126, 132 and the long side panel sections 128, 136 to shift to mirrored positions substantially orthogonal to the base panel section 124.

The folding of the four fold sections 158, 160, 180, 182, brings the single transverse tab 138 to overlap the double transverse tab 145. The outer portion 200 of the double transverse tab 145 may be folded over the single transverse tab 138 so that the inner portion 198 is on one side of the single transverse tab 138 and the outer portion 200 is on the opposite side of the single transverse tab 138. Then, the adhesive strip of the outer portion 200 may be applied to the single transverse tab 138, engaging the single transverse tab 138 and the double transverse tab 145. The engagement of the single transverse tab 138 and the double transverse tab 145 helps to keep the short side panel sections 126, 132 and the long side panel sections 128, 136 substantially orthogonal to the base panel section 124.

With the single transverse tab 138 and the double transverse tab 145 engaged, and the proximal end short side fold section 158, and the proximal end long side fold section 160 completely folded against the double transverse tab 145, the proximal end outer end wall flap 166 may be folded over to a compartment interior 202 as indicated by the arrow. As the proximal end outer end wall flap 166 is folded in to the compartment interior 202, the first wing tab 168 and the opposing second wing tab 170 are folded alongside the outer short side panel section 132 and the outer long side panel section 136. The mitered edges 204 of the proximal end transverse support tab 172 may engage one of the mitered ends 135 of the short side longitudinal support tab 134 and one of the mitered ends 142 of the long side longitudinal support tab 140. The engagement of the mitered edges 204 of the proximal end transverse support tab 172 and the one of the mitered ends 135 of the short side longitudinal support tab 134 and one of the mitered ends 142 of the long side longitudinal support tab 140 helps hold the proximal end outer end wall flap 166 against the double transverse tab 145. In this position, the first cut out 162 and second cut out 174 may align to form a common bore.

Similarly, with the distal short side fold section 180 and the distal long side fold section 182 completely folded toward the compartment interior 202, the distal end outer end wall flap 190 may be folded over the short side fold section 180, and the long side fold section 182, as indicated by the arrow. When the distal end outer end wall flap 190 is fully folded, the mitered ends 206 of the distal end transverse support tab 192 may engage one of the mitered ends 135 of the short side longitudinal support tab 134 and one of the mitered ends 142 of the long side longitudinal support tab 140. The engagement of the mitered edges 206 of the distal end transverse support tab 192 and the one of the mitered ends 135 of the short side longitudinal support tab 134 and one of the mitered ends 142 of the long side longitudinal support tab 140 helps hold the distal end outer end wall flap 190 against the short side fold section 180 and the long side fold section 182.

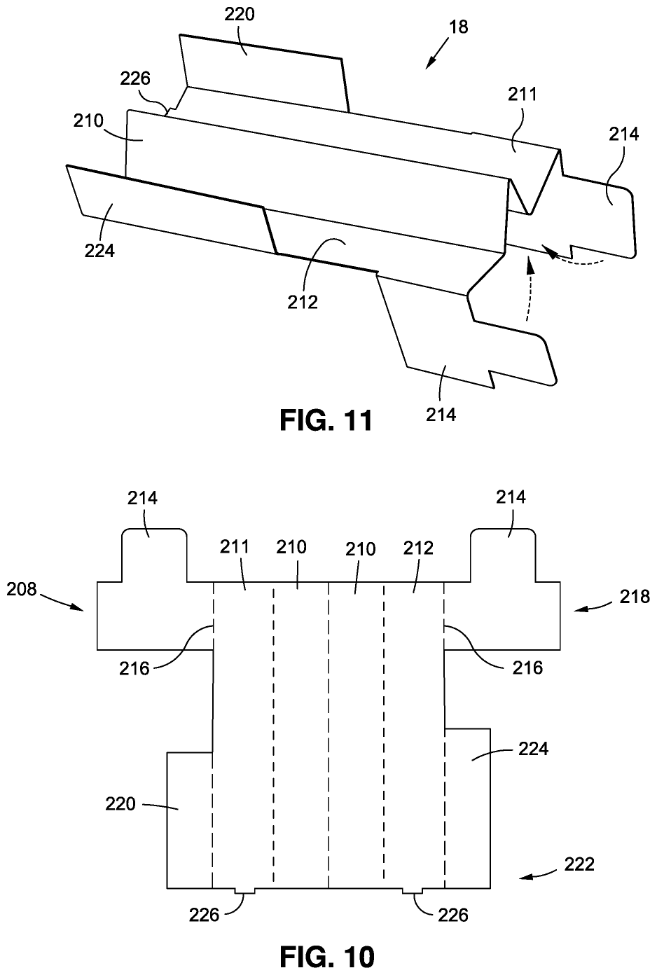

Referring now to the divider tray 18, FIGS. 10 and 11 depict a first embodiment of the divider tray 18, which may be formed from a divider tray panel 208. The divider tray panel 208 may include two inner central panel sections 210, a short side outer panel section 211 and a long side outer panel section 212. The outer central panel sections 211, 212 may include a plurality of tabs. The locations of the plurality of tabs may be mirrored on each of the outer central panel sections 211, 212. Each of the short side outer panel section 211, and the long side outer panel section 212 may have a pull tab 214 attached to a longitudinal edge 216 adjacent a proximal end 218. The short side outer panel section 211 may further include a short side biasing tab 220 attached to the longitudinal edge 216 adjacent a distal end 222. The long side outer panel section 212 may further include a long side biasing tab 224 attached to the longitudinal edge 216 adjacent the distal end 222. Both the short side outer panel section 211 and the long side out panel section 212 may have a mating tab 226 on a distal end.

As shown in FIG. 11, the divider tray panel 208 may be folded to form the divider tray 18. The two inner central panel sections 210 may be folded along a common fold line to form an inverted “V” shape, which may divide the divider tray 18 into two storage zones or regions. The short side biasing tab 220 may be folded upward so that the short side biasing tab 220 is substantially orthogonal with the adjacent short side outer panel section 211. The long side biasing tab 224 may be folded upward so that the long side biasing tab 224 is substantially orthogonal with the adjacent long side outer panel section 212. Each of the pull tabs 214 may be folded under the attached short side outer panel section 211 and long side outer panel section 212 as indicated by the arrows so that the pull tabs 214 overlap, forming a single, double thick tab.

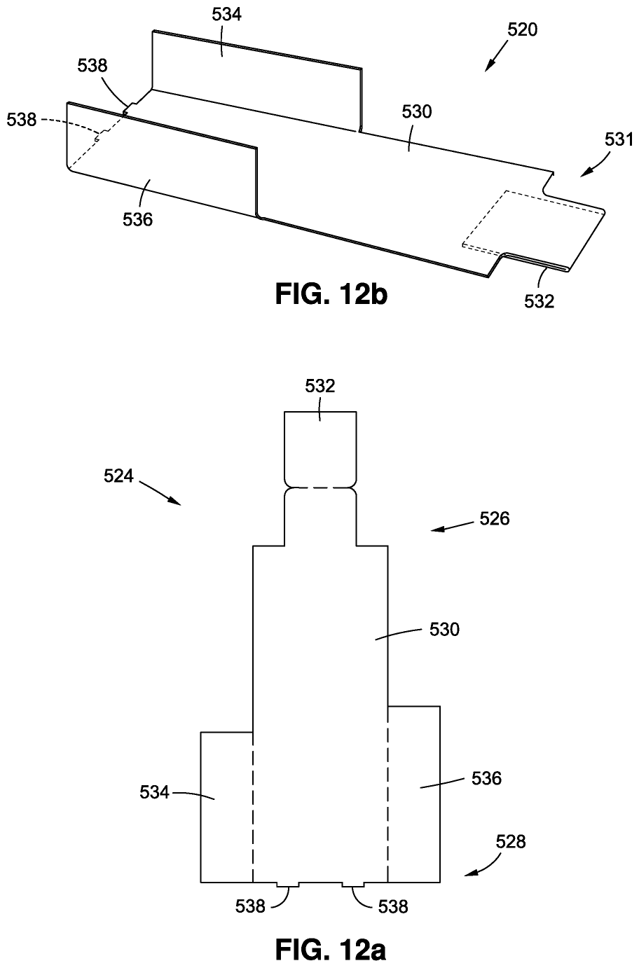

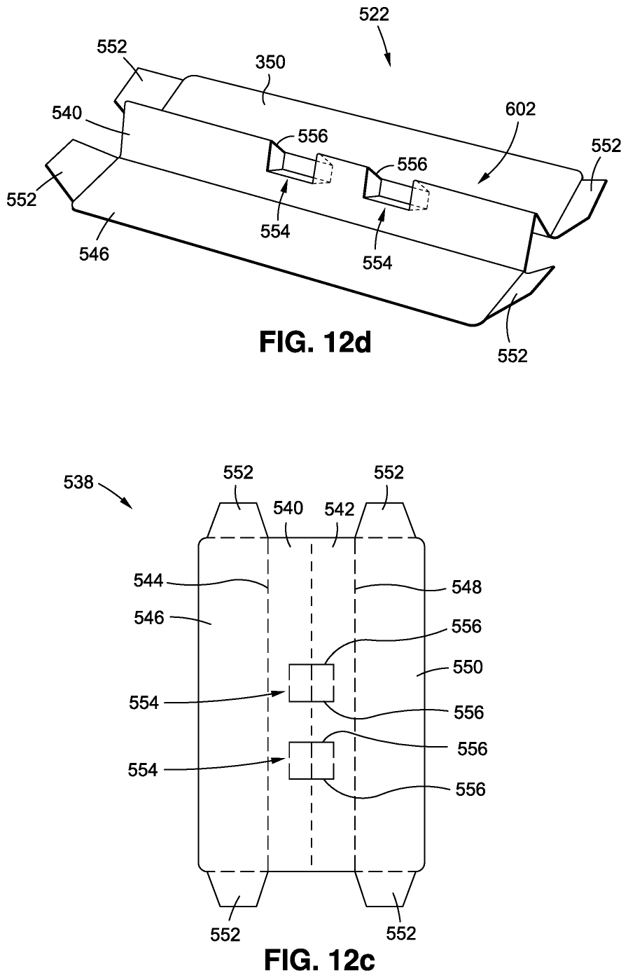

FIGS. 12a-d show a second embodiment of a divider tray. The divider tray may include a divider tray platform 520 and a divider tray cartridge holder 522. The divider tray platform 520 may be formed from a divider tray platform panel 524 having a proximal end 526 and a distal end 528. The divider tray platform panel 524 may include a base panel section 530. The base panel section 530 may have a plurality of tabs. The base panel section 530 may include a pull tab stiffener tab 532 extending from the proximal end 526. The base panel section 530 may further include a short side biasing tab 534 and a long side biasing tab 536. The short side biasing tab 534 and the long side biasing tab 536 may extend from opposing longitudinal edges of the base panel section 530 near the distal end 528 of the divider tray platform panel 524. The divider tray platform panel 524 may also include two mating tabs 538, which extend distally from the distal end 528 of the divider tray platform panel 524.

As shown in FIG. 12b, to assemble the divider tray platform 520 from the divider tray platform panel 524, the pull tab stiffener tab 532 may be folded back under and attached to the base panel section 530. The area of the base panel section 530 covered by the pull tab stiffener tab 532 may be referred to as a pull tab 531. Then, the short side biasing tab 534 and the long side biasing tab 536 may be folded upward substantially orthogonal to the base panel section 530.

As shown in FIG. 12c, the divider tray cartridge holder 522 may be further formed from a divider tray cartridge holder panel 538. The divider tray cartridge holder panel 538 may include a first central panel section 540 and an attached and opposing second central panel section 542. Attached along an outer edge 544 of the first central panel section 540 may be a first bottom panel section 546. Attached along an outer edge 548 of the second central panel section 542 is a second bottom panel section 550. Mating tabs 552 may extend from both a proximal and a distal end of the first bottom panel section 546 and the second bottom panel section 550. Storage notches 554 may extend across portions of both of the first central panel section 540 and the second central panel section 542. Each storage notch 554 may be formed by cutting two substantially parallel slits 556. Each slit 556 may extend from a point substantially in the middle of the width of the first central panel section 540 to a point substantially in the middle of the width of the second central panel section 542. Each slit 556 is spaced apart from the other slits 556 by substantially the same distance.

As shown in FIG. 12d, to assemble the divider tray cartridge holder panel 538, a user may fold the first central panel section 540 and the second central panel section 542 upward along the fold line between the first central panel section 540 and the second central panel section 542, so that the first central panel section 540 and the second central panel section 542 form an inverted “V” shape to separate the divider tray into two storage zones or regions. The storage notches 556 may be folded in a direction opposite to the first central panel section 540 and the second central panel section 542 so that the portions of the first central panel section 540 and the second central panel section 542 defined by the slits form upright “V” shapes. The mating tabs 552 may be bent upward in the same direction as the first central panel section 540 and the second central panel section 542. The divider tray cartridge holder panel 538 may be placed in the divider tray platform 520 so that the first bottom panel section 546 and the second bottom panel section 550 sit between the short side biasing tab 534 and the long side biasing tab 536. Similar to the first embodiment, once the divider tray cartridge holder 522 is placed in the divider tray platform 520, the divider tray cartridge holder 522 may at least partially define an interior 602.

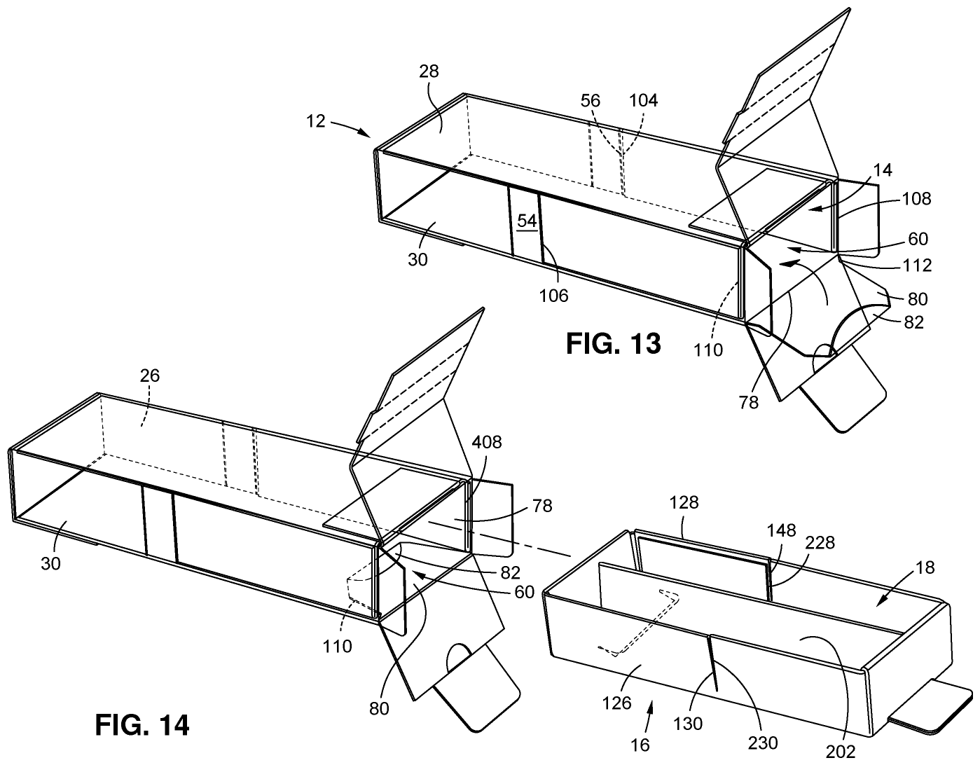

With the basic structure of each component described above, the following discussion relates to assembling the components and use of the package. As shown in FIG. 13, once the insert 14 is in the folded configuration described above, the insert 14 may be placed in the interior 60 of the outer shell 12, such that the insert 14 and the outer shell 13 collectively define a housing. A short side panel interior edge 104, and a long side panel interior edge 106 of the insert 14 may align with respective slits 56 of the release section 54 in the second panel section 26 and fourth panel section 30 of the outer shell 12. A short side panel exterior edge 108 and a long side exterior edge 110 of the insert 14 may align with a section of the proximal end portion opening 78. The central panel section 102 may be sized and shaped to substantially cover an interior surface of the third panel section 28 of the outer shell 12. After the insert 14 is placed in the interior 60 of the outer shell 12, the catch tab 82 may be folded back to an interior surface of the blocking flap 80. The blocking flap 80 is then folded in to the interior 60 of the outer shell 12 as shown by the arrow, so that the catch tab 82 is between the blocking flap 80 and the fifth panel section 32 of the outer shell. Once the blocking flap 80 is folded in to position, the chamfered shoulders 112 of the blocking flap 80 may engage the short side panel exterior edge 108 and long side panel exterior edge 110 to hold the insert 14 in place in the interior 60. The inherent resiliency of the fold line between the blocking flap 80 and the catch tab 82 causes the catch tab 82 to hold the blocking flap 80 up from an interior surface of the fifth panel section 32. The housing defined by the outer shell 12 and insert 14 may include an internal recess extending from a first open end thereof to an opposing second closed end thereof.

Assembly of the package 10 may further entail placement of the divider tray 18 or divider tray 518 in the compartment 16 to collectively define a tray having an open faced storage compartment. First, the pull tabs 214 or the pull tab 531 may be inserted through the common bore formed by the first cut out 162 and second cut out 174. Then, the mating tabs 226 or mating tabs 552 may be placed in the corresponding one of the pair of mating cut outs 194.

With regard to the first embodiment of the divider tray 18, a relative width of the base panel section 124 and the short side outer panel section 211 and long side outer panel section 212 force the two inner central panel sections 210 into a configuration where both inner central panel sections 210 are substantially orthogonal to the short side outer panel section 211 and long side outer panel section 212. The resiliency of the fold lines between the short side outer panel section 211 and the short side biasing tab 220 may cause the short side biasing tab 220 of the divider tray 18 to bias outward against the outer short side panel section 128 of the compartment 16. Likewise, the resiliency of the fold lines between the long side outer panel section 212 and the long side biasing tab 224 may cause the long side biasing tab 224 of the divider tray 18 to bias outward against the outer long side panel section 132 of the compartment 16.

With regard to the second embodiment of the divider tray 518, the first bottom panel section 546 and the second bottom panel section 550 may perform a similar function as the inner central panel sections 210, by holding the first central panel section 540 and second central panel section 542 in the inverted “V” shape. Similar to the first embodiment, the short side biasing tab 534 and the long side biasing tab 536 may bias outward against the outer short side panel section 128 and the outer long side panel section 132 of the compartment 16. As configured, the storage notches 554 may hold vials or other containers of material.

As shown in FIGS. 13-16, in operation, the compartment interior 202, 602 may be filled with a product or containers having product within. The compartment 16 may then be placed in the interior 60 of the outer shell 12. As can best be seen in FIGS. 13 and 14, a user may slide the compartment 16 in to the outer shell 12 through the proximal end portion opening 78. As the compartment 16 slides in, the compartment 16 compresses the catch tab 82 flat between the fifth panel section 32 and the blocking flap 80. As a user continues to slide the compartment 16 into the outer shell 12, the inner long side panel section 128 and inner short side panel section 126 are biased outward and pivot around the folds line between the inner long side panel section 128 and the base panel section 124 and the inner short side panel section 126 and the base panel section 124, respectively. The biasing force may be provided by the resiliency inherent in the material of the compartment panel 116 and the divider tray panel 208, 524. For instance, the long side biasing tab 224, 536 of the divider tray panel 208, 524 may be biased outwardly. Likewise, the outer long side panel section 136, the long side longitudinal support tab 140, and the outer long side panel section 136 of the compartment 16 may also be biased outwardly. Furthermore, the short side biasing tab 220, 534 of the divider tray panel 208, 524 may be biased outwardly, and, the outer short side panel section 132, the short side longitudinal support tab 134, and the outer short side panel section 132 of the compartment 16 may also be biased outwardly.

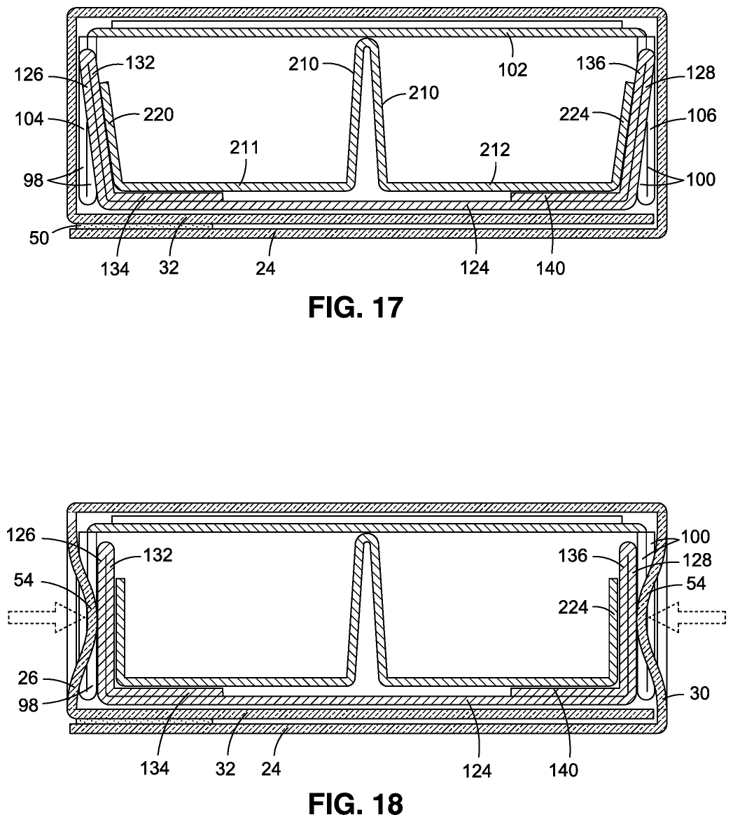

As can be seen in FIGS. 13, 14, 15 and 17, once the short side slit 130 and the long side slit 148 of the compartment 16 pass the respective short side panel interior edge 104 and the long side panel interior edge 106 of the insert 14, the panel section 126 of the compartment 16 may be biased into contact with the fourth panel section 30 of the outer shell 12, and the panel section 128 of the compartment 16 may be biased into contact with the second panel section 26 of the outer shell 12. In this first position, the long side slit edge face 228 and the short side slit edge face 230 may be exposed. Each of the short side panel interior edge 104, and the long side panel interior edge 106 may form respective first detent elements or housing abutments. Each of the long side slit edge face 228 and the short side slit edge face 230 may form respective second detent elements or tray abutments. In this first position, each of the combination of the short side panel interior edge 104 and the short side slit edge face 230, and the long side panel interior edge 106 and the long side slit edge face 228 may form a detent arrangement. Said another way, the first detent element may form a detent arrangement with the corresponding second detent element.

The slit edge faces 228, 230 may be aligned with the corresponding one of the panel interior edges 104, 106. Each slit edge face 228, 230 faces 180 degrees from the one of the panel interior edges 104, 106. Thus, when they are brought in to contact, the detent arrangement prevents any further movement of the compartment 16 toward the proximal end portion opening 78. One of ordinary skill in the art will understand that the detent arrangement may be formed from a variety of physical structures without departing from the spirit of this aspect of the inventive subject matter. For example, the detent arrangement may be formed by a boss and a divot, or a slot which moves to bring to solid surfaces in to contact, or a ball detent.

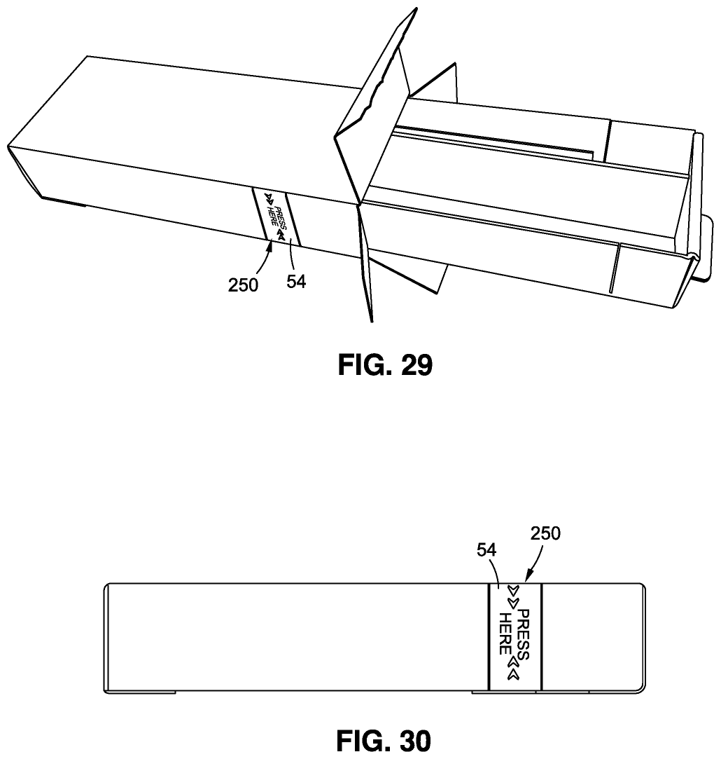

To release the detent arrangement a user may exert an inward force on the release sections 54 as shown by the arrows in FIGS. 5 and 16. As can be seen in FIGS. 29 and 30, the release sections 54 may be marked with graphics 250. The graphics may include, for example, instructions. For example, the release sections 54 may be marked with “release here.” As can be seen in FIGS. 15 and 16, when there is more than one release section 54 on the outer shell 12, the release sections 54 may be longitudinally offset on opposite sides of the outer shell 12. In other words, one release section 54 may be closer to the proximal end portion opening 78 than the other release section 54. For example, one release section 54 may be formed on the second panel section 26 and a second release section 54 may be formed on the fourth panel section 30. The offset positioning assists in making it more difficult for a child to figure out proper hand positioning to release the compartment 16. Although two offset releases are shown, it is contemplated that the releases could be opposed in non-offset relationship. Also, two release sections 54 are provided, one on each side of the packaging, again to complicate access, however, it is contemplated that a single release mechanism may be employed. As can be seen in FIGS. 5, 16, and 18, the inward force may distort the shape of the release sections 54, causing the release sections 54 to bow inward relative to the remaining portion of the respective panels. Due to the contact between the inner side panel sections 126, 128, and the respective second panel section 26 and fourth panel section 30, the inward bowing of the release sections 54 may bias the inner side panel sections 126, 128 inward to a more upright alignment and out of alignment with the short side panels 98 and long side panels 100. While still providing the inward force on the release sections 54, as can be seen in FIG. 16, a user may pull the pull tabs 214, translating the compartment 16 toward and then through the proximal end portion opening 78.

As shown in FIG. 16, once the second detent element has moved proximal of the first detent element, the pharmaceutical packaging 10 is in a second position. In this position, the detent arrangement is not engaged.

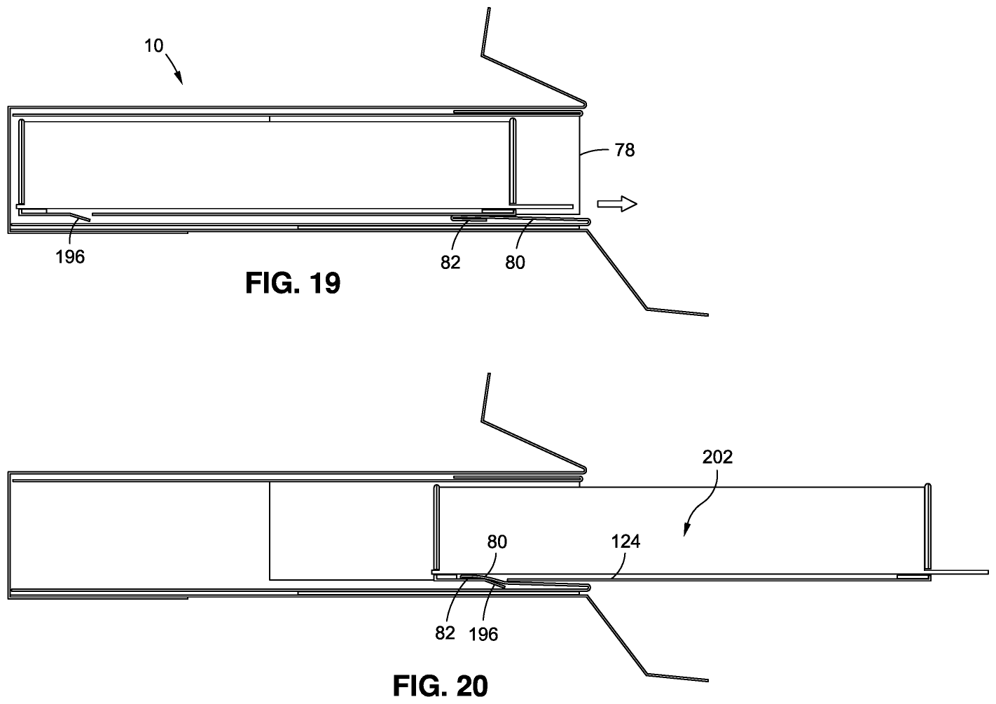

As can be seen in FIGS. 19 and 20, when a catch tab 82 and hooking tab 196 are present, the catch tab 82 may capture or engage with the hooking tab 196 as the compartment 16 translates toward the proximal end portion opening 78 to prevent or mitigate further outward translation of the compartment 16 relative to the outer shell 14. The catch tab 82 and blocking flap 80 will move between the hooking tab 196 and the base panel section 124, preventing further translation of the compartment 16 toward or through the proximal end portion opening 78. The compartment interior 202 may be easily accessed when the pharmaceutical packaging 10 is in this state. The pharmaceutical packaging 10 may be returned to the first position by translating the compartment 16 until the second detent element is distal of the first detent element. In the first position the pharmaceutical packaging 10 may be resealed by folding in the two opposing lateral tabs 70, and then coving them with the covering flap 84. Next, the resealing tab 86 may be placed in the slot 90, which holds the covering tab 84 in place, and reseals the pharmaceutical packaging 10.

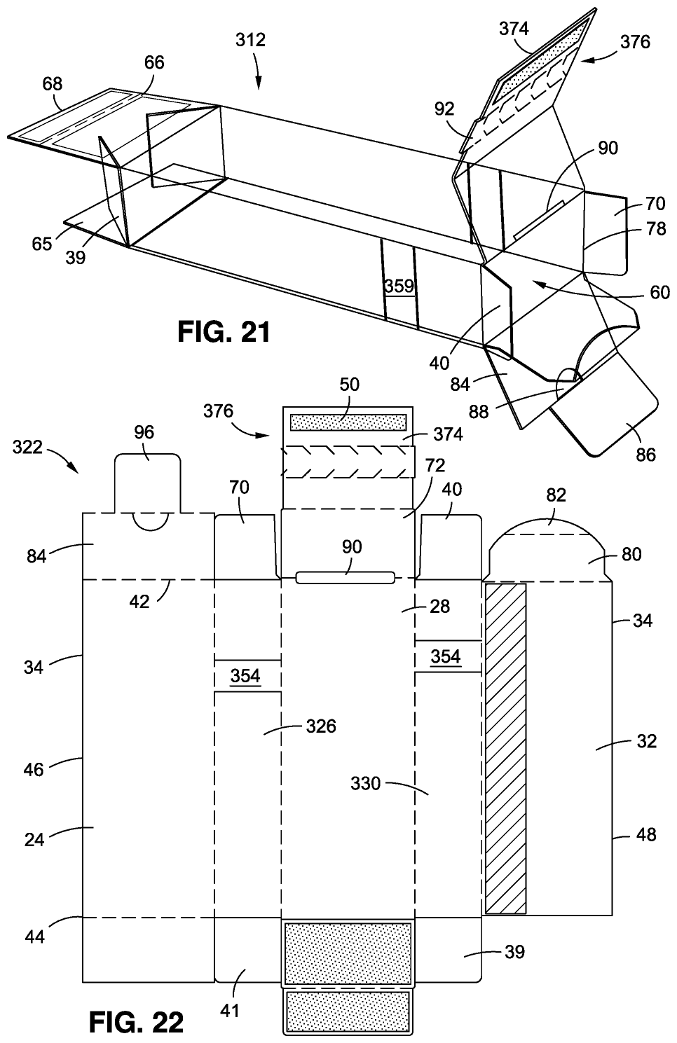

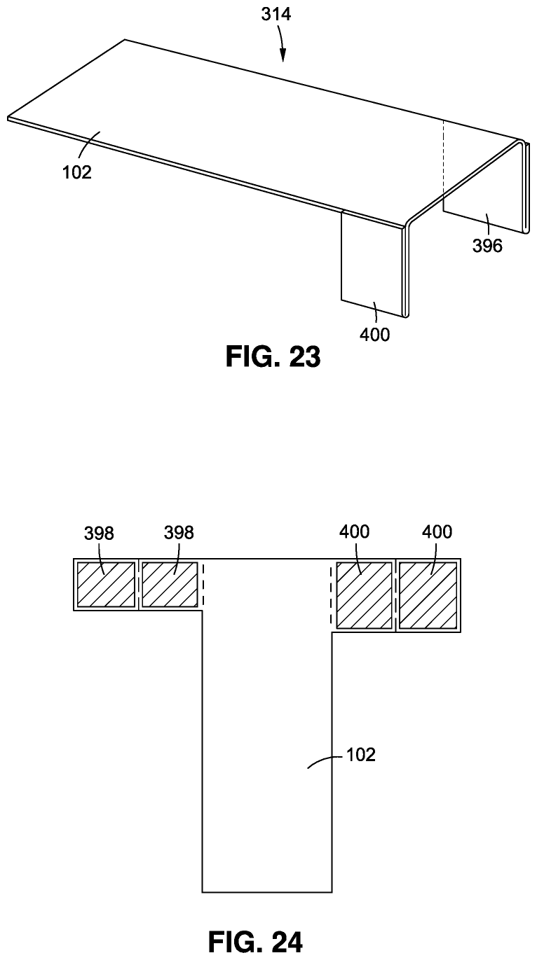

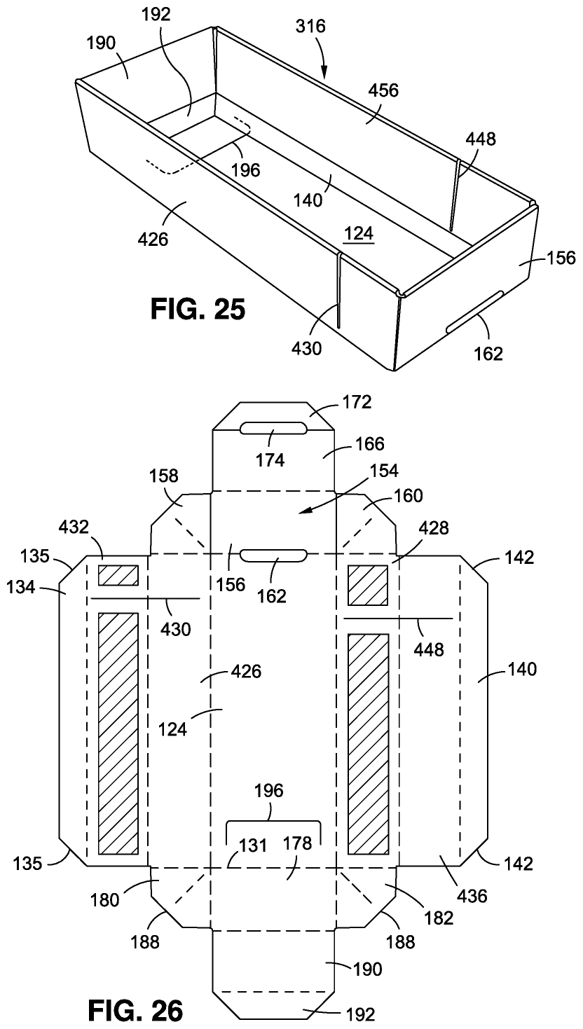

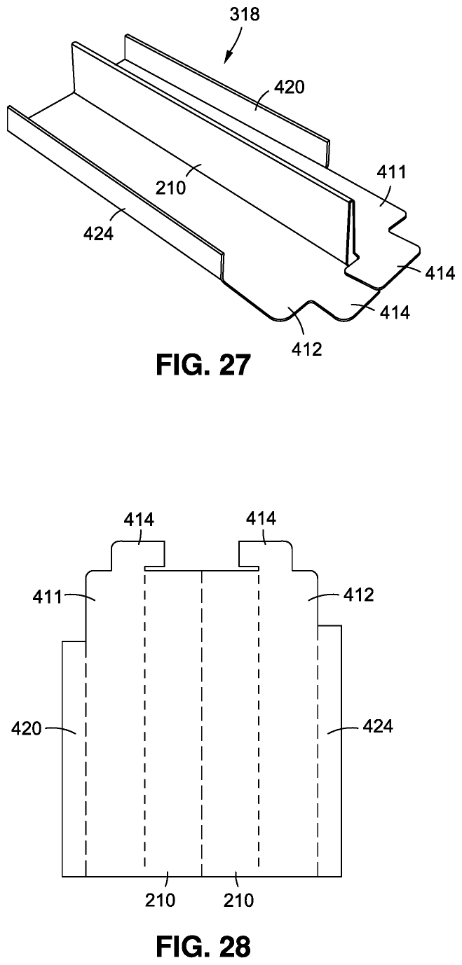

Referring now to FIGS. 21-28 there is depicted a second embodiment of the pharmaceutical packaging 310. Similar to the first embodiment, the second embodiment includes an outer shell 312, an insert 314, a compartment 316, which includes a divider tray 318. The pharmaceutical packaging 310 is substantially as described above and operates as described above. Like reference numerals indicate like structures. Thus, similar referenced structures are as described above, but with differences noted.

The outer shell 312 is similar to the outer shell 12 described above. However, in this embodiment, the frangible lines of weakness 376 on an opening tab 374 include perforations which extend at an angle. As shown, the perforated sections of the two frangible lines of weakness 376 mirror one another. Collectively, the frangible lines of weakness 376 form a tear away strip. Additionally, the release sections 354 on the second panel section 326 and fourth panel section 330 are closer to the proximal end of the outer shell panel 322. As shown in FIGS. 21, 22, 24 and 26 regions or rectangles on the container surface that are shown in diagonal lines or dotted regions are areas of pre-affixed adhesives.

Correspondingly, the insert 314 includes short side panels 398 and long side panels 400. However, because of the positioning of the release sections 354 on the outer shell 312, both the short side panels 398 and long side panels 400 are shorter than the corresponding structures in the first embodiment. As noted above, however, the operation is substantially the same.

As with the first embodiment, the second embodiment includes a compartment 316. The compartment 316 omits some structure present in compartment 16. Compartment 316 does not include the single transverse tab 138 or double transverse tab 145. A short side slit 430 and long side slit 448 cut in the inner short side panel 426 section and outer short side panel section 432, and inner long side panel section 428 and outer long side panel section 436, respectively, are cut closer to the proximal end to align with the release sections 354. Otherwise, compartment 316 is structurally the same as compartment 16 and is assembled and operates in the same manner.

The divider tray 318 includes structural differences which are also based on the location of the release sections 354. In the divider tray 318, the short side biasing tab 420, and long side biasing tab 424 are both longer than their counterparts in the first embodiment. In addition, the short side biasing tab 420 and long side biasing tab 424 may be more narrow, or shorter when folded in to their assembled configuration than their counterparts in the first embodiment. Alternatively, the short side biasing tab 420 and long side biasing tab 424 may have the same width or height as their counterparts in the first embodiment.

The divider tray 318 may also include pull tabs 414. The pull tabs 414 extend from a proximal end of the short side outer panel section 411 and long side outer panel section 412. Further, when a divider tray panel 408 is folded, the pull tabs 414 overlap only over the portion of the pull tabs 414 not directly proximal of the short side outer panel section 411 and long side outer panel section 412.

The above description is given by way of example, and not limitation. Given the above disclosure, one skilled in the art could devise variations that are within the scope and spirit of the inventive subject matter disclosed herein, including various ways of forming the detent arrangement. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An access resistant package comprising:
a housing having:
a first end;
a second end opposite the first end, the second end including an opening;
an internal recess extending from the first end to the second end; and
a first housing abutment extending within the internal recess; and
a tray having an open faced storage compartment and a first tray abutment, the tray being insertable within the internal recess and selectively positionable relative to the housing in a first position and a second position;
in the first position, the tray being positioned within the internal recess such that the housing covers the open faced storage compartment and the first housing abutment engages the first tray abutment to restrict inadvertent removal of the tray from the internal recess;
in the second position, a portion of the tray extending through the opening and out of the internal recess to facilitate access to the open faced storage compartment, the first housing abutment being moved out of engagement with the first tray abutment to facilitate movement of the tray from the first position toward the second position.

2. The access resistant package recited in claim 1, wherein the first tray abutment is moveable and disengageable from the first housing abutment in response to application of a force which urges the first tray abutment toward the storage compartment.

3. The access resistant package recited in claim 1, wherein the tray includes a first portion including the first tray abutment, and a second portion, the first tray abutment being moveable relative to the second portion to facilitate disengagement of the first tray abutment from the first housing abutment.

4. The access resistant package recited in claim 3, wherein the tray includes a slit extending between the first portion and the second portion.

5. The access resistant package recited in claim 1, wherein the housing includes a second housing abutment extending within the internal recess and the tray includes a second tray abutment engageable with the second housing abutment when the tray is in the first position, the second housing abutment being moved out of engagement with the second tray abutment to facilitate movement of the tray from the first position toward the second position.

6. The access resistant package recited in claim 5, wherein the package defines a longitudinal axis along which the tray is moveable relative to the housing, the first and second tray abutments being spaced from each other along the longitudinal axis to define an offset configuration.

7. The access resistant package recited in claim 1, wherein the housing includes a body and an insert positioned within the body, the insert including a distal edge defining the first abutment, the tray being slidable relative to the insert as the tray transitions from the first position to the second position.

8. The access resistant package recited in claim 1, wherein the tray includes a bottom surface having a slit formed therein and the housing includes a stop extending into the internal recess, the stop being received in the slit when the tray is in the second position to restrict further removal of the tray from the housing.

9. The access resistant package recited in claim 1, wherein the tray includes a divider wall separating the storage compartment into two zones.

10. Access resistant packaging comprising:
an elongate package housing having:
a plurality of elongate housing walls, a closed second end and a first end having an opening, the elongate housing walls forming an interior surface; and
at least one of the elongate housing walls having a pliable region, and at least one raised surface formed on an interior of said housing wall; and
a package tray having a bottom, a plurality of elongate tray sides walls, a front wall and a rear wall, the package tray being sized to be insertable within the package housing through the opening of the first end, at least one of the plurality of elongate tray side walls having a deformable catch;
wherein the package tray is movable relative to the package housing to assume at least a first position and a second fully inserted position, in the first position, the deformable catch is disengaged from the raised surface of the package housing, and in the second position the deformable catch expands outwardly to become engaged with the raised surface to resist removal of the tray from the package housing; and
wherein the pliable region of the package housing wall is configured to urge the deformable catch to move inwardly to disengage from the raised surface and allow removal of the tray from said housing in response to application of an inward force on the pliable region.

11. The access resistant packaging of claim 10, wherein the pliable region comprises a cut formed into the elongate housing wall, the area adjacent the cut defining a deformable area on the elongate housing wall.

12. The access resistant packaging of claim 10, wherein the pliable region comprises at least two cuts formed into the elongate housing wall, the area between the cuts defining a deformable area on the elongate housing wall.

13. The access resistant packaging of claim 10, wherein the plurality of elongate housing walls form four sides the package housing.

14. The access resistant packaging of claim 13, wherein the pliable region is formed on at least one of the four sides of the package housing.

15. The access resistant packaging of claim 13, the package housing including at least two pliable regions formed on at least two opposed sides of the four sides of the package housing.

16. The access resistant packaging of claim 10, wherein the elongate package housing is formed from cardboard.

17. The access resistant packaging of claim 10, wherein the elongate package housing is formed from a plastic material.

18. The access resistant packaging of claim 10, wherein the deformable catch is formed by a cut in at least one of the elongate tray side walls.

19. The access resistant packaging of claim 10, wherein the package tray includes a divider wall to separate a storage area of the package tray into two zones.

20. A method of assembling pharmaceutical packaging, the method comprising:
folding a housing along fold lines such that the housing defines an enclosure having an internal recess extending from a first end to a second end, the housing further including a first housing abutment extending within the internal recess;
placing a tray in the internal recess, the tray having an open faced storage compartment and a first tray abutment, the tray being selectively positionable relative to the housing in a first position and a second position;
in the first position, the tray being positioned within the internal recess such that the housing covers the open faced storage compartment and the first housing abutment engages the first tray abutment to restrict inadvertent removal of the tray from the internal recess;
in the second position, a portion of the tray extending out of the internal recess to facilitate access to the open faced storage compartment, the first housing abutment being moved out of engagement with the first tray abutment to facilitate movement of the tray from the first position toward the second position.
